(19) United States
(12) Patent Application Publication
(10) Pub. No.: US 2010/0242572 A1
(43) Pub. Date: Sep. 30, 2010

(54) WAVELENGTH MODULATION SPECTROSCOPY FOR SIMULTANEOUS MEASUREMENT OF TWO OR MORE GAS INGREDIENTS

(76) Inventor: James Yu, Dallas, TX (US)

Correspondence Address: JAMES YU, 307 Baltimore Ave, Apt B, Monterey Park, CA, 91754, US

(21) Appl. No.: 12/438,361

(22) PCT Filed: Sep. 22, 2007
(86) PCT No.: PCT/US07/79253

§ 371 Date: Feb. 22, 2009

Related U.S. Application Data
(60) Provisional application No. 60/863,367, filed on Oct. 28, 2006.

(51) Int. Cl. G01N 21/00; G01J 3/42

(52) U.S. Cl. 73/24.02; 356/437

(57) ABSTRACT

Methods and systems to measure simultaneously concentrations or concentration ratio(s) of two or more gas ingredients in a sample area comprising: a wavelength modulated light source; an acoustic detector or a photodetector; and means to analyze the signal from the acoustic detector or the photodetector and calculate the concentrations or concentration ratio(s). The light from the light source is transmitted through the sample area. Part of the light will be absorbed in the sample area by the gas ingredients and generates photoacoustic signal. The acoustic detector is used to sample the photoacoustic signal. Alternatively, a photodetector is used to sample the light intensity after the light is transmitted through the sample area.

### TECHNICAL FIELD

The present invention relates to wavelength modulation spectroscopy, and more specifically to simultaneous measurement of concentrations of two or more gas ingredients by means of wavelength modulation spectroscopy.

### BACKGROUND OF THE INVENTION

In many applications such as a breath test, measurement of two or more gases concentrations in a sample area is needed. Martin reviewed some technologies for the detection and monitoring of gas species, with special focus on laser diode based technologies [P. A. Martin, “Near-infrared diode laser spectroscopy in chemical process and environmental air monitoring,” Chem. Soc. Rev., 31, 201-210 (2002)]. The infrared absorption spectroscopy such as the FTIR has been used for many years to measure multiple species. However the FTIR technology has poor resolution especially for some gases and is slow in measurement. In some applications, simultaneous measurement of multiple gases concentrations are realized using multiple gas cells with different light sources, where each cell only measures one gas concentration at a time.

Laser diode based technologies such as the wavelength modulation spectroscopy (WMS) are also used to measure gas concentration(s) and have the advantage of high sensitivity. In a typical WMS the wavelength of the light source is modulated at a frequency f. When the light passes through a sample area, part of the light is absorbed by the target gas ingredient(s). The absorption can be measured with an acoustic detector to measure the photoacoustic signal or a photodetector to measure the light intensity after the light is transmitted through the sample area. The wavelength modulation of the light source will create an amplitude-modulated signal of the detector. The signal from the detector can then be demodulated at a frequency v to output the absorption information. When the demodulation frequency v is selected from the modulation frequency f and its harmonics, the demodulation is called homodyne demodulation; otherwise it is called heterodyne demodulation. A lot of prior efforts in the WMS focused on the improvement of the sensitivity for single gas ingredient measurement.

In Silver and Bomse's invention (“Wavelength modulation spectroscopy with multiple harmonic detection,” U.S. Pat. No. 6,356,350, issued Mar. 12, 2002), they described an improvement of the WMS with a photodetector that can measure absorption line shape of one gas in the presence of one spectroscopic interference by using a laser wavelength stepper (a “laser sweep function” device). They further stated that their invention could be used for multiple absorbance measurement. Their method however needs to use the laser wavelength stepper to scan the averaged wavelength or the center wavelength of the wavelength modulation period through the absorption line profile and is time consuming. Many other existing WMS methods also require additional scanning mechanism (to change the averaged wavelength or the wavelength center of the wavelength modulation period) in addition to the wavelength modulation to measure two or more gas ingredients. The present invention requires no additional scanning mechanism besides the wavelength modulation. Bomse described an improvement for the WMS using a heterodyne demodulation method with a photodetector (“Phaseless wavelength modulation spectroscopy,” U.S. Pat. No. 5,973,782, issued Oct. 26, 1999). In his invention, he also stated one of the advantages of his invention was the potential application for simultaneous detection of several gases. However he did not provide a detailed description to perform the detection, nor did he discuss the applicable conditions and the limitations of his invention for multiple gases detection. The light absorption profile of a gas is usually influenced by many factors such as temperature, pressure, and gas composition of the sample area. The present invention provides improvements for the WMS that can simultaneously measure concentrations or concentration ratio(s) of two or more gas ingredients using a homodyne or heterodyne demodulation method with an acoustic detector or a photodetector. In general, the homodyne demodulation method has better signal-to-noise ratio and also is easier to implement.

In the WMS based on a laser diode, the wavelength of the laser is modulated within a range of wavelength. The modulation of the laser wavelength is usually achieved by modulating the current of a laser diode while keeping the laser diode at a constant temperature. Pilgrim and Bomse described a step shape modulation waveform of the laser wavelength for the WMS used in a photoacoustic spectrometer (“Wavelength modulated photoacoustic spectrometer,” U.S. Pat. No. 6,552,792B1, issued Apr. 22, 2003). However this kind of wavelength waveform is hard to implement in real application because the laser diode wavelength depends on not only the laser diode current but also the history of the laser diode current when the laser diode is not operating in DC mode. A step shape current waveform does not result in a step shape wavelength waveform. For example, when a laser diode is driven by a square wave current to generate laser at both low and high currents, its wavelength will scan through a range of wavelength at either the low current or the high current in the square wave, furthermore the scan rate of the wavelength at either current is not a linear function of time.

In applications, temperature stabilized semiconductor DFB or DBR or VCSEL lasers are used preferably in the WMS due to their excellent stability and sharp laser line width. Nevertheless, an LED may also be used in the WMS as the light source for which the modulation will result in periodic change in the light wavelength profile and therefore may result in the modulation of the absorption profile. Other types of light sources may also be used if a wavelength modulation scheme is still applicable.

An important application of multiple gas ingredients measurement is the measurement of the ratio of ¹²CO₂ and ¹³CO₂ in human breath in clinical diagnosis. Technologies used in clinics for the ratio measurement include mass spectrometry and broadband infrared light source based infrared spectroscopy. Technology based on diode laser did not reach the sensitivity and fast response requirements for many clinical applications in prior efforts. Our present invention provides a new technology based on laser diode or other semiconductor lasers (such as quantum cascade laser) capable to meet the requirements and further provides potential to lower the cost against the existing technologies.

### SUMMARY OF THE INVENTION

The present invention provides systems and methods to measure simultaneously the concentrations or the concentration ratio(s) of two or more gas ingredients having different absorption spectra in the wavelength modulation range in a sample area using wavelength modulation spectroscopy comprising: generating wavelength modulated light at a modulation frequency f from a light source; transmitting the light through the sample area; means to measure the sample area absorption of the light; means to analyze the measured signal(s) and calculate the concentrations or the concentration ratio(s) of the gas ingredients.

In accordance with the preferred embodiments of the present invention, means to measure the sample area absorption of the light comprises one of the following two methods,
(1) using at least one acoustic detector such as a microphone in the sample area to sample the photoacoustic sound produced by the modulated light being transmitted through the sample area,
(2) using a photodetector to sample the light intensity of the modulated light after the light is transmitted through the sampling area.
These two methods can also be used together to provide the absorption information.

In accordance with the preferred embodiments of the present invention, means to analyze the measured detector signal(s) and calculate the concentrations or the concentration ratio(s) of the gas ingredients uses homodyne or heterodyne demodulation to demodulate the measured signal to provide the amplitudes and phases (A₁, φ₁, A₂, φ₂, A₃, φ₃, . . . , Aₙ, φₙ) of selected frequency components in the signal, where Aᵢ and φᵢ are the amplitude and the phase of the frequency component for the ith selected frequency (i=1, 2, 3, . . . , n) and the selected frequencies are selected among the modulation frequency f and its harmonics. In addition, the DC component amplitude A₀ in the photodetector signal may also be measured. The amplitudes and phases (A₁, φ₁, A₂, φ₂, A₃, . . . , Aₙ, φₙ) provided by the demodulation (and the DC component A₀ if it is also measured) can then be used to calculate the concentrations or the concentration ratio(s) of the gas ingredients. For convenience, these amplitudes and phases will be referred to as an absorption vector in the amplitudes and phases space (in many engineering applications, the amplitudes and phases space is often called as frequency domain). In general many factors, such as temperature, pressure, gas composition and absorption saturation effects in the sample area, can influence the absorption spectra (and therefore the absorption vector) within the modulation cycle for each or some gas ingredient(s) to be measured. The concentrations or the concentration ratio(s) of the gas ingredients can be calculated using interpolation or extrapolation techniques for the absorption vector based on a set of calibration vectors (each calibration vector is an absorption vector obtained in a calibration process for a gas sample with known concentrations of the gas ingredients), or using theoretical models describing the absorption spectra of the gas ingredients. For the calculation additional sensors may be needed to measure factors such as temperature, pressure and some background gas ingredients in the sample area. Alternatively, the analysis and calculation can also be performed in a linear subspace of the amplitudes and phases space. The dimension of the subspace should be the same as or larger than the number of the gas ingredients to be measured. A larger dimension may be helpful in some applications to reduce the measurement errors. In some applications where there exists some background gas ingredient(s) (such as water vapor) which concentration can be measured directly by other sensor(s) (such as a humidity sensor) and which also absorbs the modulated light (therefore generates a background absorption signal) with a known absorption profile, the influence of the light absorption by the background gas ingredient(s) can be subtracted from the measured detector signal accordingly. In some applications where the gas sample is contained inside a cell and isolated from the outside atmosphere environment, additional means can be used to control the temperature, the pressure (or the partial pressure) of the gas sample to facilitate the calibration and the measurement.

In some applications, the absorption line shape for each gas ingredient to be measured is or can be considered unchanged for the ranges of the measurement environmental conditions, such as the ranges of temperature, pressure, relative humidity and other gas composition ratios in the sample area. In this case, the absorption vector (after the subtraction of the baseline and the background signal) for each gas ingredient can be scaled to a constant associated unit vector with the scaling coefficient associated with the concentration of the gas ingredient. The associated unit vector and the conversion between the scaling coefficient and the concentration can be obtained in the calibration process for each gas ingredient. To calculate the concentrations or the concentration ratio(s) of the gas ingredients in the sample area, the absorption vector of the unknown gas sample in the sample area can be decomposed into a unique linear combination of the associated unit vectors of the gas ingredients (where the baseline and the background signal have been subtracted for all the absorption vectors), provided that the associated unit vectors of the gas ingredients are linearly independent. The coefficient of each associated unit vector in the linear combination is the scaling coefficient for the respective gas ingredient to retrieve its concentration in the sample.

Absorption of the modulated light by some interferences and the fixture elements within or adjacent to the sample area such as dust, mist, optics and windows (if existed) for transmitting the light into the sample area and walls (if existed) enclosing the sample area is often referred to as background absorption. An adequate modeling for the background absorption is needed when the background absorption is not negligible. A constant background absorption can be treated as baseline. In some applications the background absorption has a known absorption profile, therefore can be treated as a special kind of “gas ingredient” in the measured signal analysis. A typical example of such known absorption profile is one that only depends on the light intensity and is independent of wavelength within the wavelength modulation range of the light.

In the present invention, a gas ingredient to be measured can be a gas with one single type of molecule or a gas mixture of several types of molecules, where different types of molecules have different chemical structures or different molecular weights (e.g., molecules with similar chemical structure but different isotopic elements, such as ¹²CO₂ and ¹³CO₂ will be regarded as different types of molecules). When two types of molecules defined in the gas mixture for a gas ingredient have the same absorption profile and do not have any distinguishable effect on the absorption profile of any gas ingredient, the two types of molecules can be treated as one special type of molecule. If at least one gas ingredient is defined as a gas mixture of at least two types of molecules according to fixed mixed ratio(s), the measured concentration of a gas ingredient may be negative in some cases (in these cases at least two gas ingredients contain a same type of molecule).

In accordance with the first and second preferred embodiments, the present invention uses homodyne demodulation to demodulate the measured signal at the frequency or frequencies selected among the modulation frequency f and its harmonics to provide the amplitudes and phases (A₁, φ₁, A₂, φ₂, A₃, φ₃, . . . , Aₙ, φₙ) of selected frequencies components in the signal, where Aᵢ and φᵢ are the amplitude and the phase of the frequency component for the ith selected frequency (i=1, 2, 3, . . . , n). In addition, the DC component A₀ in the signal can also be calculated in the second preferred embodiment.

In accordance with the third and forth preferred embodiments, the present invention uses heterodyne demodulation to demodulate the measured signal to provide the amplitudes and phases (A₁, φ₁, A₂, φ₂, A₃, φ₃, . . . , Aₙ, φₙ) of selected frequencies components in the signal, where Aᵢ and φᵢ are the amplitude and the phase of the frequency component for the ith selected frequency fᵢ (i=1, 2, 3, . . . , n) and the selected frequencies are selected among the modulation frequency f and its harmonics. The heterodyne demodulation can be performed by demodulating the measured signal at the frequency or frequencies vᵢ (i=1, 2, 3, . . . , n) selected among the frequency v and its harmonics, where v=f+δ with 0<|δ|<<f and |vᵢ−fᵢ|<<f (in the third and forth preferred embodiments, δ=f/m with m>>1, where m is an integer).

In the present invention, transmitting the light through a sample area means that the light can pass one time or multiple times through the sample area.

The present invention further provides systems and methods to measure the difference(s) between two sample areas in concentrations or concentration ratio(s) of two or more gas ingredients having different absorption spectra in the wavelength modulation range using wavelength modulation spectroscopy comprising: generating wavelength modulated light at a modulation frequency f from a light source; transmitting the light through the sample areas; means to measure the absorptions of the light in the sample areas; means to analyze the measured signals and calculate the difference(s) in concentrations or concentration ratio(s) of the gas ingredients in the sample areas. A method to calculate the difference(s) is to calculate the concentrations or concentration ratio(s) in each sample area and then calculate the difference(s). When the light is transmitted through two sample areas in sequence and the absorption of the light by the first transmitted sample area is not negligible, the measured signal(s) in the second sample area will depend on the concentrations of the gas ingredients in the first sample area. When the profile of the light entering the first sample area is known but the profile of the light entering the second sample area is unknown, one method is to calculate the concentrations of the gas ingredients in the first sample area first, which can provide a modified light profile after the light passes through the first sample area, then the modified light profile can be used to calculate the concentrations of the gas ingredients in the second sample area.

The present invention further provides a system and method in wavelength modulation spectroscopy to modulate the wavelength of a temperature stabilized semiconductor DFB or DBR or VCSEL laser source using a waveform for the light source current in which the current is kept constant for a finite period of time and the wavelength or the averaged wavelength of the laser is scanned through a range of wavelength during the finite period of time. The present invention further provides a system and method in wavelength modulation spectroscopy to modulate the wavelength of a temperature stabilized light source using a square waveform for the light source current, where the averaged wavelength of the modulated light during the high or the low current of the square waveform current is scanned through a range of wavelength.

### BRIEF DESCRIPTION OF THE DRAWINGS

FIG. 1 is the block diagram for a first preferred embodiment of the present invention.

FIG. 2 is the block diagram for a second preferred embodiment of the present invention.

FIG. 3 is the block diagram for a third preferred embodiment of the present invention.

FIG. 4 is the block diagram for a fourth preferred embodiment of the present invention.

### DESCRIPTION OF THE PREFERRED EMBODIMENTS

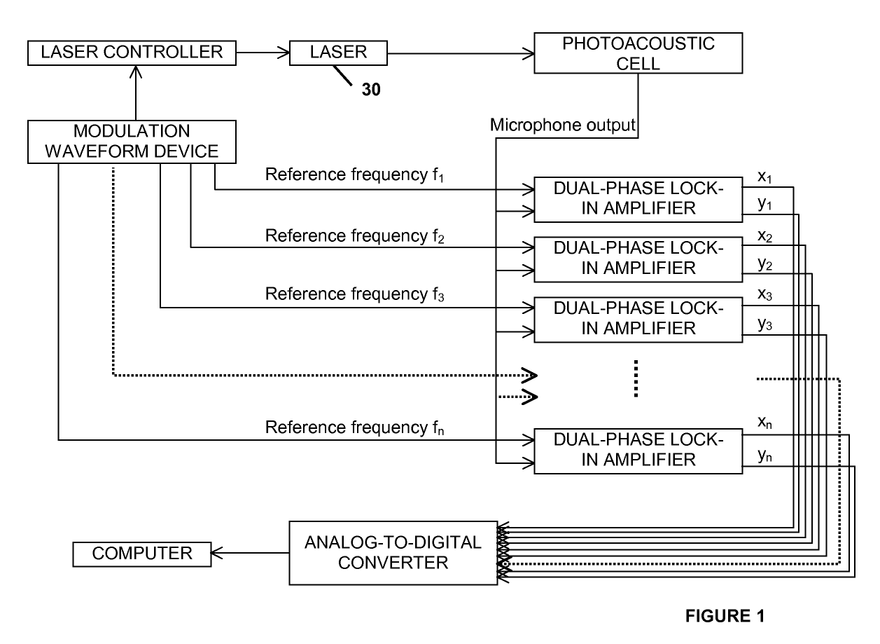

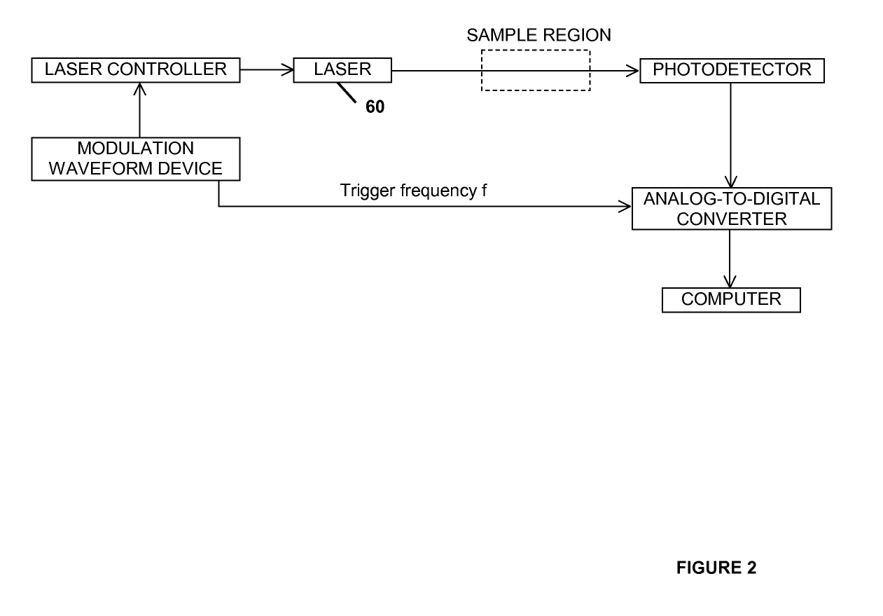

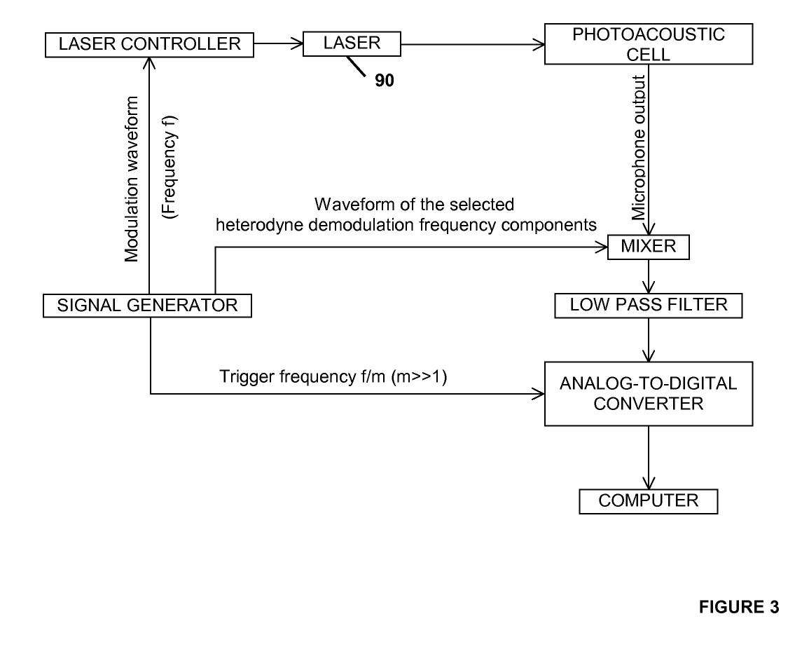

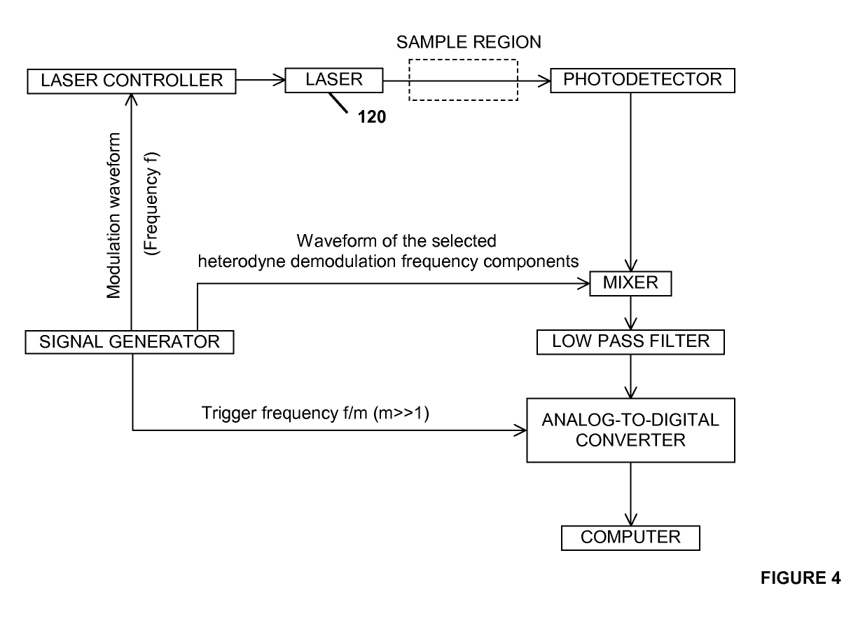

In the following discussion of four preferred embodiments of the present invention, the first two corresponding FIG. 1 and FIG. 2 use homodyne demodulation to demodulate the detector signal, while the third and the fourth as shown in FIG. 3 and FIG. 4 use heterodyne demodulation. The following descriptions for the embodiments describe the methods to measure the absorption vectors from the microphone or photodetector signals. The measured absorption vectors can be used to calculate the concentrations or the concentration ratio(s) of the target gas ingredients according to the methods described earlier in “Summary of Invention.”

In a first preferred embodiment as illustrated in FIG. 1 block diagram, the laser controller uses the waveform generated by the modulation waveform device at a frequency f to generate a modulated current to drive the laser 30, and the laser 30 generates a wavelength modulated light that is collimated into the photoacoustic cell. The laser controller also stabilizes the temperature of the laser 30. The modulation waveform device also outputs a set of reference signals at frequencies (f₁, f₂, f₃, . . . , fₙ) to be used by the dual-phase lock-in amplifiers to demodulate the microphone signal, where the frequencies (f₁, f₂, f₃, . . . , fₙ) are different from each other and are selected from the modulation frequency f and its harmonics. The photoacoustic cell contains the sample gas to be measured for the concentrations or the concentration ratio(s) of the two or more gas ingredients. A microphone is used in the photoacoustic cell to measure the photoacoustic signal. Each dual-phase lock-in amplifier outputs two demodulation signals (xᵢ, yᵢ) (i=1, 2, 3, . . . , n) where xᵢ is the demodulation amplitude with a zero phase difference (“in-phase”) against the reference frequency fᵢ and yᵢ is the demodulation amplitude with a π/2 phase lag (“out-of-phase”) against the reference frequency fᵢ. Each set (xᵢ, yᵢ) are input to an analog-to-digital converter connected to a computer. The computer can calculate the amplitude and phase (Aᵢ, φᵢ) from (xᵢ, yᵢ) for each demodulation frequency component according to their relationship xᵢ=Aᵢcosφᵢ and yᵢ=Aᵢsinφᵢ. Because the subspace (Aᵢ, φᵢ) (expressed using polar coordinates) is same as (xᵢ , yᵢ) (expressed using Cartesian coordinates), either (A₁, φ₁, A₂, φ₂, A₃, φ₃, . . . , Aₙ, φₙ) or (x₁, y₁, x₂, y₂, x₃, y₃, . . . , xₙ, yₙ) can be used to denote the absorption vector.

As an example for the first preferred embodiment, the system is used to measure the concentration ratio of ¹²CO₂ and ¹³CO₂ where only a dual-phase lock-in amplifier is needed and the demodulation frequency is the same as the modulation frequency. A temperature-stabilized distributed feed back (DFB) laser diode can be used as the light source and the wavelength modulation range of the laser diode can be selected according to the CO₂ spectra in the HITRAN database. The ratio in the atmosphere for ¹²CO₂ and ¹³CO₂ is approximately 99:1. In many clinical applications the variation of the ratio is at the order of a few percent or smaller. In order to reduce the signal dynamic range requirement of the signal processing and improve the sensitivity, two gas ingredients to be measured for concentration are redefined as (1) CO₂ containing 99% of ¹²CO₂ and 1% of ¹³CO₂; (2) ¹³CO₂ (the concentration ratio of ¹²CO₂ and ¹³CO₂ can be retrieved easily from the concentrations of the two defined gas ingredients). Furthermore, the modulation waveform for the laser diode is designed with a special effect that the amplitude of the absorption vector of the first gas ingredient (i.e., CO₂ containing 99% of ¹²CO₂ and 1% of ¹³CO₂) is not zero but much smaller than that of the absorption contribution from individual isotopic molecule alone (i.e., ¹²CO₂ or ¹³CO₂), where the baseline and the background signal have been subtracted for all the absorption vectors. For some modulation wavelength range where water vapor absorption is not negligible, additional lock-in amplifier (either single phase or dual-phase) can be used to demodulate the signal at an additional demodulation frequency to increase the dimension of the absorption vector space in order to measure the three gases ingredients concentration. Alternatively, a humidity monitor can be used to measure the water vapor concentration and subtract the water vapor absorption influence in the measured absorption vector if the water vapor absorption vector can be retrieved according to the theoretical model or the measurements in the calibration process.

In a second preferred embodiment as illustrated in FIG. 2 block diagram, the laser controller uses the waveform generated by the modulation waveform device at a frequency f to generate a modulated current to drive the laser 60, and the laser 60 generates a wavelength modulated light that is collimated into the sample region. The laser controller also stabilizes the temperature of the laser 60. The modulation waveform device also outputs a trigger at a frequency f to trigger the analog-to-digital converter to record the waveform of the detector signal. The sample region contains the sample gas to be measured for the concentrations or the concentration ratio(s) of the two or more gas ingredients. The sample region may or may not have physical walls to contain the sample gas (e.g., the sample region in a sample cell has physical walls, while the sample region in a lidar application for an open place does not have physical walls to contain the sample gas). The photodetector detects the light intensity after the modulated light is transmitted through the sample area. The light intensity signal from the photodetector is input to an analog-to-digital converter connected to a computer. The computer records and analyzes the waveform of the light intensity signal. The waveform can be recorded multiple times and averaged to improve signal-to-noise ratio. The computer can calculate the DC component amplitude A₀ and the amplitudes and phases for selected frequency components among the modulation frequency f and its harmonics in the detector signal based on Fourier transform. The demodulation value set vector (A₀, A₁, φ₁, A₂, φ₂, A₃, φ₃, . . . , Aₙ, φₙ) can be used as the absorption vector where n is the number of frequencies selected for analysis, and Aᵢ and φᵢ are the amplitude and the phase for the ith selected frequency (i=1, 2, 3, . . . , n) chosen from the modulation frequency f and its harmonics.

In the above two preferred embodiments as illustrated in FIG. 1 and FIG. 2, the signal demodulation technique based on lock-in amplifier (in FIG. 1) or the waveform recording method (in FIG. 2) can be used by each other for demodulating the microphone signal or photodetector signal.

In a third preferred embodiment as illustrated in FIG. 3 block diagram, the laser controller uses the waveform generated by the signal generator at a frequency f to generate a modulated current to drive the laser 90, and the laser 90 generates a wavelength modulated light that is collimated into the photoacoustic cell. The laser controller also stabilizes the temperature of the laser 90. The signal generator also outputs a waveform composed of frequency components of a set of reference frequencies (v₁, v₂, v₃, . . . , vₙ) to be used by the mixer to demodulate the microphone signal, where the frequencies (v₁, v₂, v₃, . . . , vₙ) are selected from the frequency (1+1/m)f and its harmonics (m is an integer and m>>1). The frequencies (v₁, v₂, v₃, . . . , vₙ) are related to frequencies (f₁, f₂, f₃, . . . , fₙ) where fᵢ is the one smaller than vᵢ and the closest to vᵢ (vᵢ−fᵢ<<f) (i=1, 2, 3, . . . , n) among f and its harmonics. The signal generator further outputs a trigger at a frequency of f/m to trigger the analog-to-digital converter to record the waveform of the low pass filter output. The low pass filter allows the signal from all the frequency components (vᵢ−fᵢ) (i=1, 2, 3, . . . , n) to pass and filters out higher frequency components. The photoacoustic cell contains the sample gas to be measured for the concentrations or the concentration ratio(s) of the two or more gas ingredients. A microphone is used in the photoacoustic cell to measure the photoacoustic signal. The computer performs a Fourier transform on the waveform recorded from the analog-to-digital converter (the waveform can be recorded multiple times and averaged to improve signal-to-noise ratio). The amplitude and phase (Aᵢ′, φᵢ′) of the frequency component (vᵢ−fᵢ) in the Fourier spectrum is related to the amplitude and phase (Aᵢ, φᵢ) of the frequency component fᵢ in the microphone output signal so that the amplitudes are proportional to each other and the phases have a constant phase shift against each other. The data set (A₁′, φ₁′, A₂′, φ₂′, A₃′, φ₃′, . . . . , Aₙ′, φₙ′) can be used to represent the absorption vector.

In a fourth preferred embodiment as illustrated in FIG. 4 block diagram, the laser controller uses the waveform generated by the signal generator at a frequency f to generate a modulated current to drive the laser 120, and the laser 120 generates a wavelength modulated light that is collimated into the sample region. The laser controller also stabilizes the temperature of the laser 120. The signal generator also outputs a waveform composed of frequency components of a set of reference frequencies (v₁, v₂, v₃, . . . , vₙ) to be used by the mixer to demodulate the photodetector signal, where the frequencies (v₁, v₂, v₃, . . . , vₙ) are selected from the frequency (1+1/m)f and its harmonics (m is an integer and m>>1). The frequencies (v₁, v₂, v₃, . . . , vₙ) are related to frequencies (f₁, f₂, f₃, . . . , fₙ) where fᵢ is the one smaller than vᵢ and the closest to vᵢ (vᵢ−fᵢ<<f) (i=1, 2, 3, . . . , n) among f and its harmonics. The signal generator further outputs a trigger at a frequency of f/m to trigger the analog-to-digital converter to record the waveform of the low pass filter output. The low pass filter allows the signal from all the frequency components (vᵢ−fᵢ) (i=1, 2, 3, . . . , n) to pass and filters out higher frequency components. The sample region contains the sample gas to be measured for the concentrations or the concentration ratio(s) of the two or more gas ingredients. The sample region may or may not have physical walls to contain the sample gas (e.g., the sample region in a sample cell has physical walls, while the sample region in a lidar application for an open place does not have physical walls to contain the sample gas). The photodetector detects the light intensity after the modulated light is transmitted through the sample region. The computer performs a Fourier transform on the waveform recorded from the analog-to-digital converter (the waveform can be recorded multiple times and averaged to improve signal-to-noise ratio). The amplitude and phase (Aᵢ′, φᵢ′) of the frequency component (vᵢ−fᵢ) in the Fourier spectrum is related to the amplitude and phase (Aᵢ, φᵢ) of the frequency component fᵢ in the photodetector output signal so that the amplitudes are proportional to each other and the phases have a constant phase shift against each other. The data set (A₁′, φ₁′, A₂′, φ₂′, A₃′, φ₃′, . . . , Aₙ′, φₙ′) can be used to represent the absorption vector.

In some applications using the first or the third preferred embodiment, a resonant photoacoustic cell can be used to improve the system sensitivity, where one resonant frequency (e.g., the lowest resonant frequency) of the photoacoustic cell is essentially same as one of the frequencies among the modulation frequency f and its harmonics. Furthermore, more than one microphone can be used for measuring photoacoustic signals containing either different or same frequency components. For the first embodiment, signals of the microphones containing different frequency components can be used to input to different lock-in amplifiers. Signals containing the same frequency components can be combined together to reduce the noise. For both the first and the third embodiments, signals from different microphones can be combined together as a single signal. Additional microphones in area essentially free of photoacoustic effect can also be used for differential measurement to remove the environmental acoustic noise.

A reference cell can be used in the preferred embodiments to provide real time calibration and reduce errors caused by, e.g., system drifts. Means to provide pressure equilibrium between the sample cell and the reference cell may be required to reduce errors caused by the differences in the pressure effects on the absorption signals between them. For the preferred embodiments, the sample gas can also be temperature stabilized to reduce temperature effect on the measured signals if the gas is confined in a container cell. Furthermore if the sampled gas is from human breath, the temperature of the container cell can be set at or above human body temperature to avoid the condensation of the water vapor inside the sample cell. Alternatively the sampled gas from the human breath can be cooled down before input into the sample cell. Additional signal amplifier can be used in the preferred embodiments to amplify the detector signal before demodulation. A light intensity monitor can also be used to monitor the intensity drift or fluctuation of the modulation light before the light is transmitted through the sample area using a portion of the light by means of a beam splitter. The light sources that can be used for wavelength modulation in the present invention include but are not limited to, laser diode, quantum cascade laser, and LED. Wavelength modulation can also use means other than current modulation, e.g., an electro-optic modulator.

The above preferred embodiments and discussions provide examples to implement the present invention, and should not be construed as the limitations to the scope of the present invention. Variations and modifications of the present invention will be obvious, or can be learned during the practice of the present invention for those skilled in the art. The scope of the present invention will be defined by the claims.

1. A wavelength modulation spectroscopy system to measure simultaneously the concentrations or the concentration ratio(s) of at least two gas ingredients in a sample area, comprising:
generating wavelength modulated light at a modulation frequency f from a light source;
said gas ingredients having different absorption spectra in the wavelength modulation range of said light;
transmitting said light through said sample area;
means to measure the absorption of said light in said sample area and provide measured signal(s);
means to analyze said measured signal(s) and calculate said concentrations or said concentration ratio(s).

2. The system of claim 1 wherein means to measure the absorption of said light in said sample area and provide measured signal(s) includes at least one acoustic detector to sample the photoacoustic sound in said sample area, said photoacoustic sound is produced by said light in said sample area.

3. The system of claim 1 wherein means to measure the absorption of said light in said sample area and provide measured signal(s) includes a photodetector to sample the light intensity of said light after said light is transmitted through said sampling area.

4. The system of claim 1, further comprising demodulation means to demodulate said measured signal(s) at selected frequency or frequencies, said selected frequency or frequencies are selected among said modulation frequency f and its harmonics.

5. The system of claim 1, further comprising demodulation means to demodulate said measured signal(s) at selected frequency or frequencies, said selected frequency or frequencies are selected among the frequency v and its harmonics where v=f+δ, 0<n|δ|<<f and the largest selected frequency among said selected frequency or frequencies is the nth (n is a positive integer) harmonics of v.

6. The system of claim 1, wherein at least one of said gas ingredients is defined as a mixture of at least two different types of molecules, said different types of molecules are molecules with different molecular weights or different molecular structures.

7. The system of claim 1, wherein said light source comprises at least one semiconductor laser source, said laser source is stabilized in temperature.

8. The system of claim 1, further comprising means to measure at least one of the parameters of temperature, pressure and other background gas ingredient(s) concentration(s) in said sample area.

9. A wavelength modulation spectroscopy method to measure simultaneously the concentrations or the concentration ratio(s) of at least two gas ingredients in a sample area, comprising:
generating wavelength modulated light at a modulation frequency f from a light source;
said gas ingredients having different absorption spectra in the wavelength modulation range of said light;
transmitting said light through said sample area;
means to measure the absorption of said light in said sample area and provide measured signal(s);
means to analyze said measured signal(s) and calculate said concentrations or said concentration ratio(s).

10. The method of claim 9 wherein means to measure the absorption of said light in said sample area and provide measured signal(s) includes at least one acoustic detector to sample the photoacoustic sound in said sample area, said photoacoustic sound is produced by said light in said sample area.

11. The method of claim 9 wherein means to measure the absorption of said light in said sample area and provide measured signal(s) includes a photodetector to sample the light intensity of said light after said light is transmitted through said sampling area.

12. The method of claim 9, further comprising demodulation means to demodulate said measured signal(s) at selected frequency or frequencies, said selected frequency or frequencies are selected among said modulation frequency f and its harmonics.

13. The method of claim 9, further comprising demodulation means to demodulate said measured signal(s) at selected frequency or frequencies, said selected frequency or frequencies are selected among the frequency v and its harmonics where v=f+δ, 0<n|δ|<<f and the largest selected frequency among said selected frequency or frequencies is the nth (n is a positive integer) harmonics of v.

14. The method of claim 9, wherein at least one of said gas ingredients is defined as a mixture of at least two different types of molecules, said different types of molecules are molecules with different molecular weights or different molecular structures.

15. The method of claim 9, wherein said light source comprises at least one semiconductor laser source, said laser source is stabilized in temperature.

16. The method of claim 9, further comprising means to measure at least one of the parameters of temperature, pressure and other background gas ingredient(s) concentration(s) in said sample area.

17. A wavelength modulation spectroscopy system to measure the difference(s) in concentrations or concentration ratio(s) of at least two gas ingredients between two gas samples, comprising:
generating wavelength modulated light at a modulation frequency f from a light source;
said gas ingredients having different absorption spectra in the wavelength modulation range of said light;
transmitting said light through each of said gas samples;
means to measure the absorption of said light in the sample area for each of said gas samples and provide measured signals;
means to analyze said measured signals and calculate said difference(s).

18. The system of claim 17, wherein a first of said gas samples is in a first sample area and a second of said gas samples is in a second sample area, and said light is transmitted through said first and second sample areas.

19. The system of claim 17, wherein only one sample area is used to contain one gas sample at a time for said gas samples and the measurements of said absorptions are performed one after the other for said gas samples.

20. A wavelength modulation spectroscopy method to measure the difference(s) in concentrations or concentration ratio(s) of at least two gas ingredients between two gas samples, comprising:
generating wavelength modulated light at a modulation frequency f from a light source;
said gas ingredients having different absorption spectra in the wavelength modulation range of said light;
transmitting said light through each of said gas samples;
means to measure the absorption of said light in the sample area for each of said gas samples and provide measured signals;
means to analyze said measured signals and calculate said difference(s).

21. The method of claim 20, wherein a first of said gas samples is in a first sample area and a second of said gas samples is in a second sample area, and said light is transmitted through said first and second sample areas.

22. The method of claim 20, wherein only one sample area is used to contain one gas sample at a time for said gas samples and the measurements of said absorptions are performed one after the other for said gas samples.

23. A wavelength modulation spectroscopy system wherein a semiconductor DFB or DBR or VCSEL laser source is modulated by a constant current for a finite period of time to generate a laser radiation, the wavelength of said radiation scans through a range of wavelength during said finite period, said laser source is stabilized in temperature.

24. A wavelength modulation spectroscopy method wherein a semiconductor DFB or DBR or VCSEL laser source is modulated by a constant current for a finite period of time to generate a laser radiation, the wavelength of said radiation scans through a range of wavelength during said finite period, said laser source is stabilized in temperature.
